(19) United States
(12) Patent Application Publication
(10) Pub. No.: US 2023/0302948 A1
(43) Pub. Date: Sep. 28, 2023

(54) OPTIMIZING ENERGY AVAILABILITY IN AN ENERGY DISTRIBUTION NETWORK

(71) Applicant: Wireless Advanced Vehicle Electrification, LLC, Salt Lake City, UT (US)

(72) Inventors: Michael MASQUELIER, Park City, UT (US); Jory PEPPELAAR, Salt Lake City, UT (US)

(21) Appl. No.: 17/701,993

(22) Filed: Mar. 23, 2022

(51) Int. Cl. B60L 53/68; B60L 53/63; B60L 53/62

(52) U.S. Cl. CPC B60L 53/68; B60L 53/63; B60L 53/62

(57) ABSTRACT

Techniques for managing the distribution of available energy in an energy distribution network during an energy distribution operating period are described herein. Managing the distribution of available energy may be implemented to optimize availability of energy in network components, state-of-charges, cost of energy transfers between the network components, and the like. In one embodiment, a first energy distribution plan may be generated from a calculated optimal distribution of available energy in the energy distribution network. The first energy distribution plan may define desired configurations of the network components. In case of detected disruptions of current network component configurations, a second energy distribution plan may be generated to re-configure affected network components throughout the energy distribution network.

### BACKGROUND

With ever-increasing developments in automobile industries, eclectic automobiles have taken a rapid increase in the improvement of their batter performance, motor performance, and optimization of the control system. The developments in electric automobiles have been primarily focused on extending their driving ranges, battery storage, and battery life. Other developments also include the ability of the charging stations to support the energy requirements of these electric automobiles.

With their rapid increase in production, the corresponding problems of planning and constructing facilities for the charging stations have attracted extensive attention in all social circles. The number of present charging station facilities and their efficiencies may continually diminish customer satisfaction as electric automobiles gain popularity for transporting goods and services.

### BRIEF DESCRIPTION OF THE DRAWINGS

The detailed description is described with reference to the accompanying figures, in which the left-most digit(s) of a reference number identifies the figure in which the reference number first appears. The use of the same reference numbers in different figures indicates similar or identical items.

FIG. 1 is a block diagram of an example energy distribution network in which an optimization of the distribution of available energy over network components can be implemented, in accordance with at least one embodiment.

FIG. 2 is a flow diagram of an example methodological implementation for managing the distribution of available energy in the energy distribution network, in accordance with at least one embodiment.

FIG. 3 is a flow diagram of an example methodological implementation for generating an energy distribution plan, in accordance with at least one embodiment.

FIG. 4 is a flow diagram of an example methodological implementation for adjusting the energy distribution plan using stored parameter measurement thresholds, in accordance with at least one embodiment

FIG. 5 is a block diagram of an example implementation of the distribution of available energy between the network components based on different energy distribution plans, in accordance with at least one embodiment.

FIG. 6 is a swim diagram showing a dynamic configuration of the mobile energy consuming component over different energy distribution operating periods, in accordance with at least one embodiment.

FIG. 7 is a block diagram of an example energy distribution management server that can facilitate the optimal distribution of available energy throughout the energy distribution network, in accordance with at least one embodiment.

### DETAILED DESCRIPTION

### Overview

This disclosure is directed to techniques for managing distribution of available energy in an energy distribution network during an energy distribution operating period. Managing the distribution of available energy may be implemented to optimize an availability of energy in network components, state-of-charges, cost of energy transfers between the network components, and the like. Information regarding anticipated energy usage, energy availability, cost, capacity to charge, etc. may be utilized to establish an energy distribution plan that can define desired configurations of the network components, for some predetermined energy distribution operating period, in anticipation of energy transfer operations throughout the energy distribution network. The energy distribution operating period may include an operating cycle for the distribution of energy, which can be an hourly cycle, daily cycle, weekly cycle, or other cycles that may be selected by an energy distribution management. In one embodiment, the established energy distribution plan may be dynamically adjusted based upon detected or received deviations, or the presence of disrupting conditions that can affect the necessary availability of energy in the network components throughout the energy distribution network.

Network components may include energy providing components and energy consuming components. Energy providing components may include fixed charging stations, mobile charging stations, electric vehicles when configured as energy providing components, and/or dedicated energy providing electric vehicles that can be charged to supply energy to the energy consuming components. Energy consuming components may include electric vehicles or mobile charging stations that can be configured to receive energy from the energy providing components. Energy transfers may include charging or discharging of energy between an energy providing component and an energy consuming component. By way of illustration and not limitation, and as part of an energy distribution plan, an electric vehicle (i.e., an energy consuming component) may be instructed to receive energy at a geolocation of a charging station (i.e., energy providing component). In another instance, in an adjusted energy distribution plan, the same electric vehicle may be treated as the energy providing component when it is instructed to supply energy to another electric vehicle or charging station.

In various embodiments, an energy distribution management network manager may manage a group of network components, such as a group of charging stations, throughout the energy distribution network. Each of the charging stations may provide energy transfers via an electric grid source, an energy producing source (e.g., a diesel-driven electric generator), and/or an energy storage system that includes the use of one or more batteries. For a particular energy distribution operating period, the energy distribution management network manager may establish a first energy distribution plan that can define an initial configuration of each of the various network components.

Regarding these configurations, and by way of illustration and not limitation, a first energy distribution plan may define a desired state-of-charge of the energy storage systems, an amount of energy to be supplied via the electric grid sources or the energy storage systems, or other configurations of the charging stations for use or potential use during the energy distribution operating period. In this example, the first energy distribution plan may be derived from or at least based upon projected energy requirements of the network components during the energy distribution operating period.

According to additional aspects of the disclosed subject matter, the first energy distribution plan may be based at least upon current configurations of the network components relative to their projected energy requirements. Further, the first energy distribution plan may be based upon characteristics of surrounding conditions such as projected traffic and weather conditions that may affect the distribution of energy throughout the energy distribution network.

Upon configuration of the network components based upon a first energy distribution plan, the network manager may monitor for conditions that can disrupt the projected energy distributions in the configured network components throughout the energy distribution network. For example, the network manager may receive information regarding an energy distribution among the network components that disrupts the first energy distribution plan. In this example, the network manager may parse the received information to identify the details of the disruption of the first energy distribution plan. The details of the disruption may include, by way of illustration and not limitation, a breakdown of an electric grid source in a first charging station, unavailability of the battery to discharge energy in a second charging station, changes in projected electric grid source prices in a third charging station, or other conditions that disrupt the first energy distribution plan. The disruption in the first energy distribution plan, for example, may be monitored via a calculated parameter measurement such as average energy discharging rate over a particular energy distribution operating period, comparisons of received parameter measurements with corresponding stored parameter measurement thresholds such as minimum state-of-charge for proper operations, or a combination thereof.

Based upon the details of the disruption in the preceding example, the network manager may perform an adjustment of the first energy distribution plan to generate a second energy distribution plan. The adjustment may include, for example, a re-calculation of needed energy and an optimal distribution of that energy throughout the energy distribution network in view of projected needs. In one embodiment, the second energy distribution plan may correspond to an implementation of new configurations of one or more affected network components. In this embodiment, the second energy distribution plan may implement a dynamic reconfiguration of the network components.

As described herein, the detecting of the disruptions may utilize one or more preconfigured parameter measurement thresholds that are associated with a current energy distribution plan. Alternatively, a prediction model may be trained on new samples of parameter measurements that can predictively determine a need to deviate from the current energy distribution plan. In both cases, the dynamic adjustments in the configurations of the network components throughout the energy distribution network may improve efficiency in the energy distribution network management operations.

Details regarding the novel techniques referenced above are presented herein are described in detail, below, with respect to several figures that identify elements and operations used in systems, devices, methods, and computer-readable storage media that implement the techniques.

### Example Energy Distribution Network

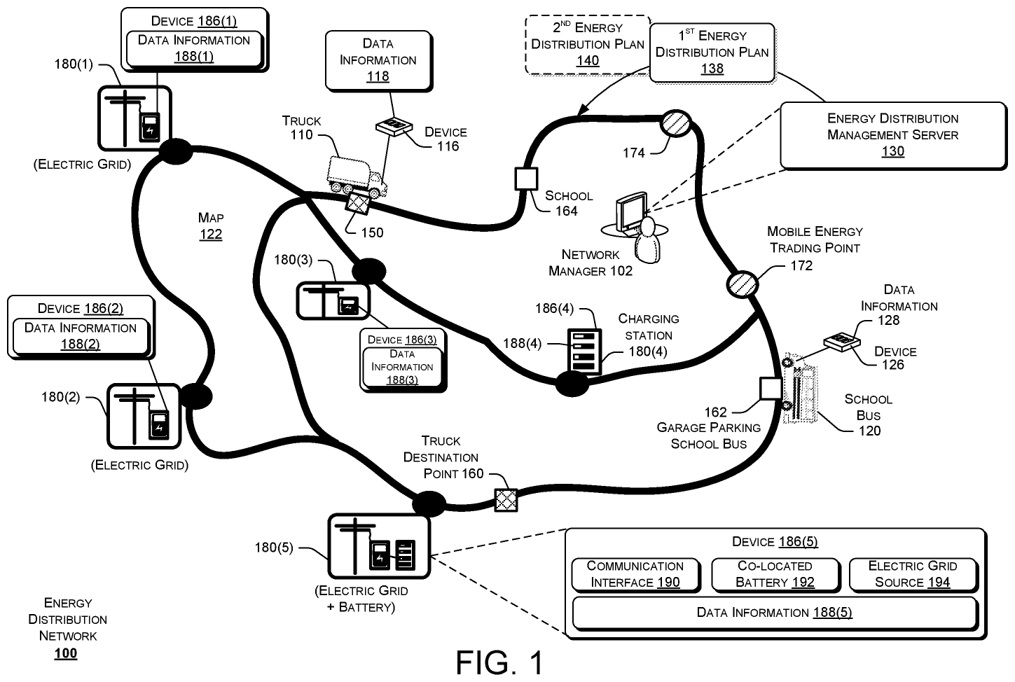

FIG. 1 is a diagram of an example energy distribution network 100 in which the technological solutions described herein may be implemented. FIG. 1 illustrates a concept of managing the distribution of available energy between the network components in the energy distribution network 100. In one example, the managing may be implemented by an energy distribution management—network manager via an energy distribution management server. The energy distribution management server may utilize data information of the network components to gather their energy transfer requirements, state-of-charges, or current configurations to calculate an optimal distribution of available energy throughout the energy distribution network 100. In one embodiment, the energy distribution management server may generate a first energy distribution plan based upon a calculated optimal distribution of energy between the network components. Upon configuration of the network components based upon the first energy distribution plan, the energy distribution management server may monitor conditions that can trigger an adjustment of the first energy distribution plan to create a second energy distribution plan. The second energy distribution plan may correspond to new energy distribution configurations of the network components in the energy distribution network 100. This technique of dynamically adjusting the current energy distribution plan may improve efficiency in energy distribution management operations and ensure available energy for anticipated energy requirements.

As shown, the energy distribution network 100 may include an energy distribution manager 102 (hereinafter referred to as network manager 102) who can manage and control the distribution of energy over energy providing components and energy consuming components such as, by way of illustration and not limitation, a truck 110, school bus 120, and charging stations 180(1)-180(5). As those skilled in the art will appreciate, the truck 110 and the school bus 120 may be treated as mobile energy consuming components that render transportation services over different locations in map 122. In one example, the truck 110 may provide delivery services from its current location 150 to a truck destination point 160 while an itinerary of the school bus 120 may include driving from a garage parking 162 to a school (geolocation) 164. The truck 110 may be associated with a device 116 and data information 118 while the school bus 120 may be associated with a device 126 and a data information 128.

The charging stations 180(1)-180(5) may be treated as energy providing components that can be disposed at different geolocations on the map 122. The charging stations 180(1)-180(5) may be associated with corresponding devices 186(1)-186(5), which are associated with data information 188(1)-188(5), respectively. In one example, the charging stations 180(1)-180(5) may include a fixed charging station with an electric grid source only (e.g., charging stations 180(1)-180(3)), a charging station with a battery only (e.g., charging station 180(4)), or a fixed charging station with an electric grid source and a co-located battery (e.g., charging station 180(5)). The charging station 180(4) that includes the battery (and without electric grid source) may be positioned in a permanent location or implemented as a mobile charging station, such as a mobile container—i.e., a charging station that can be positioned at different geolocations. The charging station 180(5) may further include a communication interface 190, a co-located battery 192, and an electric grid source 194.

For purposes of illustration, only two electric vehicles (i.e., truck 110 and school bus 120) and five charging stations (i.e., charging stations 180(1)-180(5)) are shown. However, other network components or nodes such as vans, buses, trains, cars, dedicated mobile battery containers, or fixed charging stations may be added without affecting the embodiments described herein.

In one example, the network manager 102 may utilize one or more servers such as an energy distribution management server 130 to control the distribution of energy by the charging stations 180(1)-180(5). As described herein, by way of illustration and not limitation, the energy distribution management server 130 may control and operate the charging stations 180(1)-180(5) while the truck 110 and the school bus 120 can be operated by a different server such as a vehicle-to-everything (V2X) server (not shown). In one example, the energy distribution management server 130 may generate energy distribution plans and monitor state-of-charge levels, energy availability, energy cost, battery parameters, or electric grid source parameters of the network components that it controls during the energy distribution operation.

The truck 110 and the school bus 120 may include automobiles with usable batteries for locomotion. In some cases, the truck 110 and the school bus 120 can be propelled by one or more electric motors that use the energy storage system, or in combination with their internal combustion engines in the case of hybrid vehicles. Each of these automobiles may include a vehicle identification number (VIN) that is unique for each vehicle, embedded sensors, navigation applications to identify GPS location, and other applications that may be installed in the device of the vehicle. The vehicle batteries (not shown) of truck 110 and the school bus 120 may include one or more rechargeable batteries such as lithium-ion batteries. The vehicle battery or batteries may be associated with parameters such as maximum and minimum operating voltages, maximum self-charge, the state-of-charge that can indicate a level of charge of the battery relative to its capacity, and discharging rates. These parameters may be configurable to maintain, for example, a target state-of-charge level that corresponds to an amount of energy that, at any given moment, indicates how much energy is needed to complete a task in conjunction with a current energy distribution plan. The vehicle battery parameters, VIN, and other electric vehicle configurations may be included in the data information 118 and 128 of the truck 110 and the school bus 120, respectively.

As described herein, the electric vehicles (e.g., truck 110 or school bus 120) may be treated as mobile energy consuming components or mobile energy providing components depending upon their respective configurations as defined in a current energy distribution plan. For example, in the initial energy distribution plan, the truck 110 may be treated as a first mobile energy consuming component when it receives energy from a first energy providing component, e.g., charging station 180(3). However, in case of a disruption that can trigger an adjustment in the initial energy distribution plan, the same first mobile energy consuming component, i.e., truck 110, may be treated as an energy providing component when it is instructed to share its energy to the school bus 120. In this adjusted energy distribution plan, the second energy providing component, i.e., truck 110 is also the first mobile energy consuming component in the initial energy distribution plan.

The charging stations 180(1)-180(5) (or collectively referred to as charging stations 180) may be treated as energy providing components that are configured to transfer energy to energy consuming components. The charging stations 180 may include batteries, electric grid sources, co-located batteries, or a combination thereof, each configured to at least conduct energy transfer services. In one example, the charging station 180(4) may be associated with a battery only. In another example, the charging station 180(5) may include the co-located battery 192 to support the electric grid source 194 in times of emergency like unavailability of the electric grid source, a spike in electric energy prices, or the like. The co-located battery 192 may receive energy from the electric grid source 194 of the same charging station and/or from the truck 110 or school bus 120 that can be also configured as energy providing components. The battery of the charging station 180(4) or the co-located battery 192 of the charging station 180(5) may be associated with parameters such a maximum or minimum operating voltage, maximum self-charge, state-of-charge, depth of charge, and discharging rates. These parameters may be configurable to maintain, for example, a target state-of-charge level that corresponds to an amount of energy that, at any given moment, indicates how much energy is needed in conjunction with the current energy distribution plan. The battery parameters, co-located battery parameters, charging station identification, information about pairing between the co-located battery and electric grid source in one charging station, and other charging station information may be included in the corresponding data information 188(01-188(5) of the charging stations 180(1)-180(5).

The energy distribution management server 130 may include general-purpose computers, network servers, or other electronic devices that are capable of receiving input data, processing the input data, and generating output data. The input data may include projected energy requirements of the energy providing components and/or the mobile energy consuming components during the energy distribution operating period. The input data may also include current configurations of the network components relative to their projected energy requirements. The input data may also include characteristics of surrounding conditions such as detected or projected traffic conditions, weather conditions, a spike in electricity, occurrence of accidents, presence of holiday occasions, etc. The output data may include a calculated distribution of energy by the network components that are managed or controlled by the energy distribution management server 130. The calculated optimal distribution of energy may be used as a reference to generate a first energy distribution plan 138 that can initially define configurations of the network components throughout the energy distribution network 100 for a given energy distribution plan. In case of received disruptions of the current energy distribution plan as described herein, the energy distribution management server 130 may re-calculate a second energy distribution plan 140 in order to maintain optimal distribution of energy throughout the energy distribution network 100.

By way of illustration and not limitation, the energy distribution network 100 further depicts mobile energy trading points 172 and 174 that may include preconfigured geolocations for the electric vehicles and/or mobile charging stations to meet and perform energy transfer. In one example, the energy distribution plan such as the first energy distribution plan 138 or the second energy distribution plan 140 may define the geolocations of the mobile energy trading points 172 and 174 at a particular time during the energy distribution operating period. The preconfigured geolocations of the mobile energy trading points 172 and 174 may provide optimal locations to perform the energy transfers in the energy distribution network 100. For example, the truck 110 and the school bus 120 may be instructed to relocate and perform energy transfers at the mobile energy trading point 172 based on the first energy distribution plan 138, and thereafter relocate to meet again at the mobile energy trading point 174 based on the second energy distribution plan 140.

In an example embodiment of energy distribution management, the energy distribution management server 130 may obtain projected energy requirements of the network components for a particular energy distribution operating period, current configurations of the network components relative to the projected energy requirements, characteristics of surrounding conditions during the energy distribution operating period, and other (anticipated and/or projected) information during the energy distribution operating period that can be used as input data. The energy distribution management server 130 may then use this input data to calculate and generate a first energy distribution plan 138 that can define the desired configurations of the network components including a planned distribution of energy throughout the network components. In one embodiment, the first energy distribution plan 138 ay include a calculated optimal distribution of energy such as maximum limit of energy transfers to be made by each charging station or network component, timing of energy transfers to be made by the charging stations based upon availability of batteries or electric grid sources, or electric grid source prices, amount of energy to be received by batteries based on their parameters and manufacturing specifications, and the like.

Upon configuration of the network components based on the first energy distribution plan 138, the energy distribution management server 130 may monitor conditions that can trigger adjustments of the first energy distribution plan 138, resulting in an updated, second energy distribution plan 140. The configuration of the network components may include limiting the amount of energy to be supplied by the charging stations over the energy distribution operating period, limiting the energy transfer to be made by the charging stations based upon their availability and fluctuations in electric grid source prices over the energy distribution operating period, limit energy transfer based on a limit of battery parameters such as maximum capacity or minimum state-of-charge to maintain proper operations, and the like.

For example, by way of illustration and not limitation, the charging station 180(5) may be required to supply a total of 1200 kW of energy to mobile energy consuming components throughout the energy distribution network 100 and for an energy distribution operating period of 24 hours. In this example, a calculated first energy distribution plan for the charging station 180(5) may include a discharging of energy at an average rate of 50 kW per hour (i.e., 1200 kW divided by 24 hours equals 50 kW per hour). In one embodiment, this average rate of 50 kW per hour may also be used as a discharge rate measurement threshold to detect conditions that can trigger an adjustment of the current first energy distribution plan 138 for the charging station 180(5).

For example, the charging station 180(5) is monitored to have a discharge rate measurement of 700 kW of energy within a predetermined time period of 10 hours in the current energy distribution operating period of 24 hours. The predetermined time period is a portion of the energy distribution operating period and can have unit values of hours, days, or other time periods. Since the monitored discharge rate measurement of 70 kw per hour (i.e., 700 kW divided by 10 hours equals 70 kw per hour) within the predetermined time period is greater than the discharge rate measurement threshold of 50 kW per hour, then this condition can trigger an adjustment in the current configuration of the charging station 180(5). The adjustment in the current configuration of the charging station 180(5) may include reconfiguring the charging station 180(5) to discharge energy at an average rate of 35 kW per hour for the second energy distribution plan 140. The 35 kW per hour configuration for the second energy distribution plan 140 may be derived by dividing 500 kW of available energy (i.e., 1200 kW−700 kW used=500 kW) by 14 hours, which include the number of hours left in the 24 hours—energy distribution operating period.

In the preceding example, the charging station 180(5) may be discharging energy, e.g., 70 kW per hour, that is higher than the discharge threshold because other charging stations may be offline, there is a power outage, there is a price spike in using charging stations that use electric grid sources only, and other measurement parameters that can cause disruptions in the first energy distribution plan 140. In one embodiment, the discharge rate measurement threshold of 50 kW per hour may be used as a reference for these power outages and other disruptions. In another embodiment, each of these measurement parameters may have a corresponding measurement threshold that can be used to determine the occurrence of disruptions. In another embodiment, a combination of these measurement thresholds may be used to determine the occurrence of the triggering conditions as described herein.

In another example, the charging station 180(1)-180(5) may include different energy pricing and availability to supply energy to the mobile energy consuming components during the energy distribution operating period. The energy pricing and availability may depend, for example, upon configurations of the charging station where some charging stations operate on batteries only while other charging stations operate on combinations of electric grid sources and batteries. In this example, a calculation of an optimal cost for distributing energy in the energy distribution network 100 may utilize a linear programming algorithm to generate the first energy distribution plan 138. An objective of the linear programming algorithm is to minimize cost in supplying energy to the mobile energy consuming components while the availability and pricing of each of the charging stations 180(1)-180(5) may be used as constraints or limiting factors. Upon calculation of the optimal cost, which can be used as a reference to generate the first energy distribution plan 138, the charging station 180(1)-180(5) may be configured based upon the generated first energy distribution plan 138. The configuration may include, for example, a time period to discharge energy transfer, the type of energy source to use for charging stations that operate on batteries and electric grid sources, or an amount of energy to transfer based on pricing. In this example, the configuration is carried out according to an optimal charging schedule to optimize prices and availability. In case of detected disruptions such as, by way of illustration and not limitation, a failure of the truck 110 to charge energy at a preconfigured charging station e.g., charging station 180(5), then a re-calculation of the optimal cost is performed to generate the second energy distribution plan 140.

In the above examples, the adjustment of the current configurations of the affected network components based on the first energy distribution plan 138 may include a re-calculation of the optimal distribution of energy to generate the second energy distribution plan 140. In one embodiment, the calculation and re-calculation of the optimal distribution of energy may use similar algorithms and steps to generate the desired configurations of the network components.

### Example Implementation of Managing Distributions of Available Energy

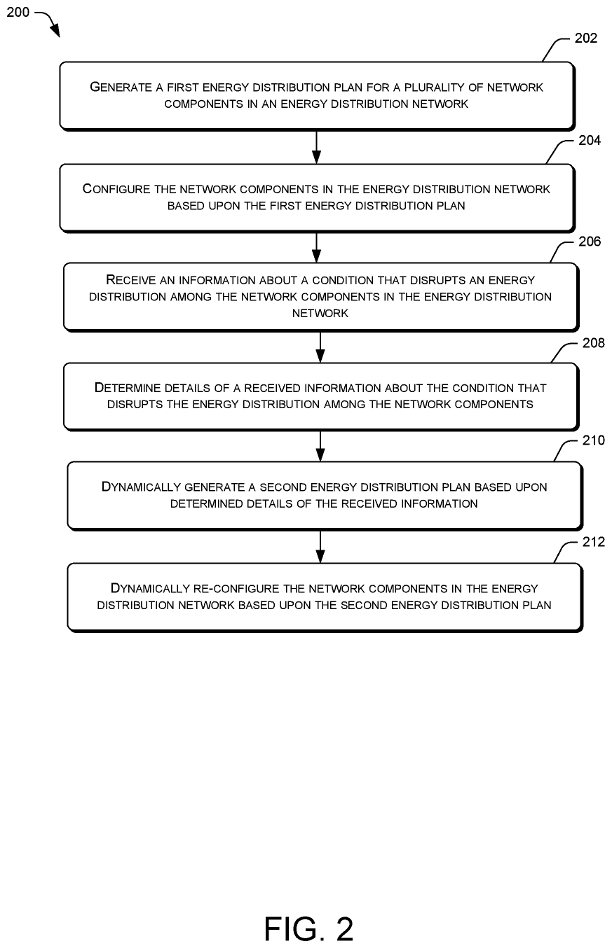

FIG. 2 is a flow diagram 200 that depicts a methodological implementation of a technique for managing the distribution of available energy in the energy distribution network 100. In the following discussion of FIG. 2, continuing reference is made to the elements and reference numerals shown in and described with respect to the energy distribution management server 130 of FIG. 1. Further, certain operations may be ascribed to particular system elements shown in previous figures. However, alternative implementations may execute certain operations in conjunction with or wholly within a different element or component of the system(s). To the extent that certain operations are described in a particular order, it is noted that some operations may be implemented in a different order to produce similar results.

At block 202, the energy distribution management server 130 may generate a first energy distribution plan for a plurality of network components in an energy distribution network 100. In one example, the energy distribution management server 130 may generate the first energy distribution plan 138 for the charging stations 180 and/or other network components in the energy distribution network 100. In this example, the first energy distribution plan 138 may define the respective configurations of the charging stations 180 and/or the other network components.

In one embodiment, and to generate the first energy distribution plan 138, the energy distribution management server 130 may obtain the data information of the network components in the energy distribution network 100. The energy distribution management server 130 may use the obtained data information to derive the energy requirements for a particular energy distribution operating period and current configurations of the network components relative to their energy requirements. The energy distribution management server 130 may further obtain current and projected characteristics of surrounding conditions during the energy distribution operating period. The obtained energy requirements, current configurations, and/or characteristics of the surrounding conditions may then be used to calculate and generate the first energy distribution plan 138.

At block 204, the energy distribution management server 130 may facilitate the configuration of the network components in the energy distribution network based upon a generated first energy distribution plan. In one embodiment, each of the network components may be configured based upon the generated first energy distribution plan 138. For example, by way of illustration and not limitation, each of the charging stations 180(1)-180(5) may be required to supply a total of 1200 kW of energy to mobile energy consuming components during an energy distribution operating period of 24 hours. In this example, a calculated first energy distribution plan 138 for the charging stations 180(1)-180(5) may include a supplying of energy at an average rate of 50 kW per hour (i.e., 1200 kW divided by 24 hours equals 50 kW per hour) by each charging station. In one embodiment, the energy distribution management server 130 may facilitate the configuration of the charging stations 180(1)-180(5) based on the calculated first energy distribution plan 138. For example, the energy distribution management server 130 may send control signals to the charging stations 180(1)-180(5) to discharge energy at the rate of 50 kW per hour. In this example, the corresponding devices of the charging stations 180(1)-180(5) may be configured to use the desired discharging rates for purposes of complying with the maximum amount of energy to supply in the first energy distribution plan 138.

At block 206, the energy distribution management server 130 may receive information about a condition that disrupts an energy distribution among the network components in the energy distribution network. In one example, the first energy distribution plan 138 may be disrupted by an occurrence or absence of an event, availability, or unavailability of storage energy system, spike in electric grid source pricing, or other forms that cause substantial deviations from the desired configurations based on the first energy distribution plan 138. In this example, the energy distribution management server 130 may receive the information from the affected one or more network components in the energy distribution network 100. Alternatively, the energy distribution management server 130 may dynamically detect the disruption through continuous monitoring of the network components in the energy distribution network 100.

At block 208, the energy distribution management server 130 may determine the details of the received information about the condition that disrupts the energy distribution among the network components in the energy distribution network. In one embodiment, the energy distribution management server 130 may parse the received information to identify the details of the disruption.

For example, the details of the received information may include the charging station 180(5) that has been discharging energy at more than the discharge energy measurement threshold. In another example, the details of the received information may include an offline charging station 180(1) that affects the discharging rate of the charging station 180(5) as a result. In another example, the details of the received information may include the presence of major traffic, bad weather conditions, road closures, traffic accidents, etc. that may affect the current configurations of the network components based on the first energy distribution plan 138. In these examples, a parameter measurement threshold such as the average rate of 50 kW per hour in the above example may be used to detect the disruptions. In other embodiments, the energy distribution management server 130 may use corresponding parameter measurement thresholds for each of the parameter measurements to detect the disruption of the first energy distribution plan. For example, the parameter measurement threshold for offline charging stations may be used to detect the charging stations that are not connected to the system, and so on.

At block 210, the energy distribution management server 130 may dynamically generate a second energy distribution plan based upon the determined details of the received information. In one example, the energy distribution management server 130 may re-calculate the optimal distribution of energy in the energy distribution network 100 to generate the second energy distribution plan 140. In some embodiments, the second energy distribution plan 140 may be applied particularly to the affected network components that are associated with configurations that deviated from the first energy distribution plan 138.

In the example above where the calculated first energy distribution plan 138 for the charging stations 180(1)-180(5) includes the supplying of energy at the average rate of 50 kW per hour (i.e., 1200 kW cap divided by 24 hours=50 kW per hour), the presence of disruption may affect the current configurations of the charging stations 180(1)-180(5) to discharge or supply energy at this average rate of 50 kW per hour. For example, due to high demand for energy transfers by the mobile energy consuming components, each of the charging stations 180(1)-180(5) supplied total energy of 700 kW out of the 1200 kW cap for a predetermined time period of 10 hours during the energy distribution operating period of 24 hours. In this example, each of the charging stations 180(1)-180(5) may be re-configured to supply energy at the average rate of 35 kW per hour for the rest of the energy distribution operating period to satisfy the 1200 kW cap requirement for each charging station. The new 35 kW per hour configuration corresponds to the second energy distribution plan 140 and can be derived by dividing 500 kW of available energy (i.e., 1200 kW−700 kW used=500 kW) by 14 hours, which include the number of hours left in the 24 hours—energy distribution operating period. In alternative embodiment, each of the charging stations 180(1)-180(5) may be configured to recharge or receive energy charges from the mobile energy providing components to maintain their desired configurations under the first energy distribution plan. In this alternative embodiment, the receiving of energy charges to maintain preconfigured battery capacity may be included in the first energy distribution plan.

At block 212, the energy distribution management server 130 may dynamically reconfigure the network components in the energy distribution network based upon the generated second energy distribution plan. In one example, the dynamic reconfiguration may include the re-configuration of the one or more network components that were affected by the disruption as described above.

### Example Implementation of Generating an Energy Distribution Plan

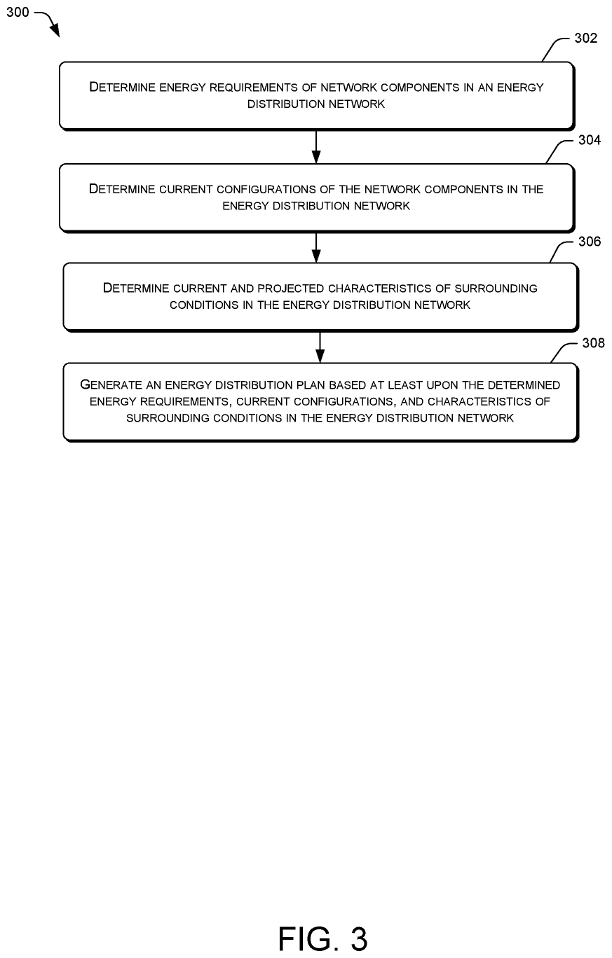

FIG. 3 is a flow diagram 300 that depicts a methodological implementation of a technique for generating an energy distribution plan that can be used to manage the distribution of available energy in the energy distribution network 100. In the following discussion of FIG. 3, continuing reference is made to the elements and reference numerals shown in and described with respect to the energy distribution management server 130 of FIG. 1. Further, certain operations may be ascribed to particular system elements shown in previous figures. However, alternative implementations may execute certain operations in conjunction with or wholly within a different element or component of the system(s). To the extent that certain operations are described in a particular order, it is noted that some operations may be implemented in a different order to produce similar results.

At block 302, the energy distribution management server 130 may determine energy requirements of the network components in an energy distribution network for a particular energy distribution operating period. In one example, the energy requirements of the network components may be determined based upon a preconfigured user input such as, an arbitrary value entered into the system by the network manager 102. In another example, the energy distribution management server 130 may directly receive the projected energy requirements from a V2X server that controls the mobile energy consuming components.

In some embodiments, the energy requirements of the network components may be based upon parameters and/or characteristics of the batteries. For example, a battery may require a minimum state-of-charge level of 50% to maintain proper operations. In another example, the battery may charge to a maximum state-of-charge level of 80%. In these examples, the parameters or the characteristics of the battery may be included in the energy requirements of the network components.

At block 304, the energy distribution management server 130 may determine current configurations of the network components in the energy distribution network. In one example, the current configurations may include battery capacities, state-of-charge level of the batteries, electric grid source availability, co-located battery availability, and/or other energy distribution conditions of the network components. In this example, the current configurations of the network components may be correlated to their respective energy requirements. In this regard, different current network component configurations may require different adjustments when implementing the generated energy distribution plan.

At block 306, the energy distribution management server 130 may determine current and projected characteristics of surrounding conditions in the energy distribution network. In one example, the characteristics of surrounding conditions may include projected traffic and weather conditions, time of day, day of the week, presence of holidays, energy fluctuation rates, and/or the like. In this example, the projected characteristics of the surrounding conditions may occur during the energy distribution operating period, which can include an energy distribution operating cycle of 1 day, 2 days, one month, etc. depending upon the cycle to be selected by the network manager 102.

At block 308, the energy distribution management server 130 may generate an energy distribution plan based at least upon the energy requirements, current configurations, and the characteristics of the surrounding conditions in the energy distribution network. In one example, the energy distribution management server 130 may use one or more algorithms to generate the first energy distribution plan 138 for the network components in the energy distribution network 100. The one or more algorithms may include the use of mathematical functions like linear programming, or a prediction model such as K-mean algorithms, maximum likelihood algorithms, Random Forest algorithms, etc.

Alternatively, the energy distribution management server 130 may use historical data to find the best match for the projected energy requirements (at block 302), current configurations (at block 304), and the current or projected characteristics of the surrounding conditions (at block 306) in the energy distribution network for the energy distribution operating period.

### Example Implementation of Adjusting the Current Energy Distribution Plan

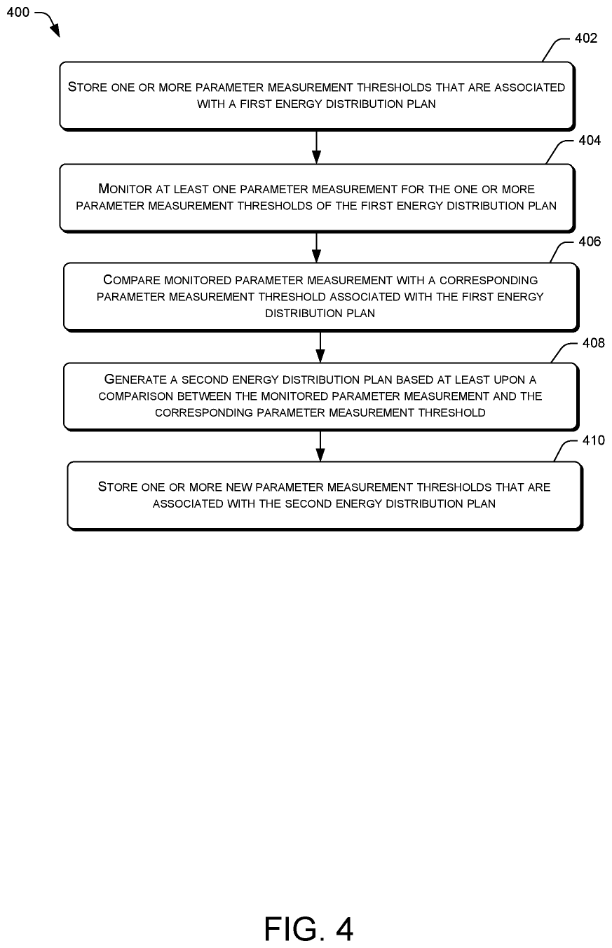

FIG. 4 is a flow diagram 400 that depicts a methodological implementation of a technique for adjusting the energy distribution plan using stored parameter measurement thresholds. In the following discussion of FIG. 4, continuing reference is made to the elements and reference numerals shown in and described with respect to the energy distribution management server 130 of FIG. 1. Further, certain operations may be ascribed to particular system elements shown in previous figures. However, alternative implementations may execute certain operations in conjunction with or wholly within a different element or component of the system(s). To the extent that certain operations are described in a particular order, it is noted that some operations may be implemented in a different order to produce similar results.

At block 402, the energy distribution management server 130 may store one or more parameter measurement thresholds that are associated with a first energy distribution plan. In one example, the parameter measurement thresholds that may be associated with the first energy distribution plan 138 may be received via a preconfigured user input or from another server. The reconfigured user input may be manually entered into the system by the network manager 102 while the other server may include a remote management server (e.g., V2X server) in addition to the energy distribution management server 130. The parameter measurement thresholds may include reference values that can be used for triggering adjustments in the current configurations of the network components in the energy distribution network 100.

For example, by way of illustration and not limitation, the charging station 180(5) may be required to supply a total of 1200 kW of energy to mobile energy consuming components throughout the energy distribution network 100 and for an energy distribution operating period of 24 hours. In this example, the calculated first energy distribution plan for the charging station 180(5) is to discharge energy at an average rate of 50 kW per hour (i.e., 1200 kW divided by 24 hours equals 50 kW per hour). In one embodiment, this average rate of 50 kW per hour may be stored and used as a discharge rate measurement threshold to detect conditions that can trigger an adjustment of the first energy distribution plan 138 for the charging station 180(5).

At block 404, the energy distribution management server 130 may monitor at least one parameter measurement for the one or more parameter measurement thresholds of the first energy distribution plan. Following the example in block 402 above, the energy distribution management server 130 may monitor the discharge rate measurement of the charging station 180(5) for a particular predetermined time period during the energy distribution operating period. The discharge rate measurement may correspond to the stored discharge rate measurement threshold (i.e., 50 kW per hour). The predetermined time period may include a portion of the energy distribution operating period of 24 hours and can have unit values of hours such as every hour, minutes such as every 100 minutes, etc.

At block 406, the energy distribution management server 130 may compare monitored parameter measurement with a corresponding parameter measurement threshold value associated with the first energy distribution plan. For example, the charging station 180(5) is monitored to have a discharge rate measurement of 700 kW of energy within a predetermined time period of 10 hours in the current energy distribution operating period of 30 hours. Since the monitored discharge rate measurement of 70 kw per hour (i.e., 700 kW divided by 10 hours equals 70 kw per hour) within the predetermined time period is greater than the discharge rate measurement threshold of 50 kW per hour, then this condition can trigger an adjustment in the current configuration of the charging station 180(5). The adjustment in the current configuration of the charging station 180(5) may include re-configuring the charging station 180(5) to discharge energy at an average rate of 35 kW per hour for the second energy distribution plan 140. The new average rate of 35 kW per hour configuration for the second energy distribution plan 140 may be derived by dividing 500 kW of available energy (i.e., 1200 kW−700 kW used=500 kW) by 14 hours, which include the number of hours left in the 24 hours—energy distribution operating period. In one embodiment, the second energy distribution plan 140 may include the 14 hours as its energy distribution operating period unless another disruption is monitored within this 14 hour—energy distribution operating period.

At block 408, the energy distribution management server 130 may generate a second energy distribution plan based at least upon a comparison between the monitored parameter measurement and the corresponding parameter measurement threshold value that is associated with the first distribution plan. In one example, the generated second energy distribution plan may include an energy distribution operating period of 14 hours, which include the number of hours left in the 24 hours, i.e., the energy distribution operating period of the first energy distribution plan.

At block 410, the energy distribution management server 130 may store one or more new parameter measurement thresholds that are associated with the second energy distribution plan. Following the example in block 406 above, the new parameter measurement thresholds may include the 35 kW per hour for the second energy distribution plan. In some embodiments, and within the 14-hour—energy distribution operating period of the second energy distribution plan, the charging station 180(5) may receive energy from a mobile energy consuming device such as the truck 110. In this case, a new third energy distribution plan may be generated and the charging station 180(5) is dynamically configured based upon the new third energy distribution plan. For example, the charging station 180(5) may be reconfigured to go back to its initial discharging rate of 50 kW per hour or more depending upon a new amount of its available energy upon energy transfers from the mobile energy consuming device.

### Example Energy Transfer Operations Based on Different Energy Distribution Plans

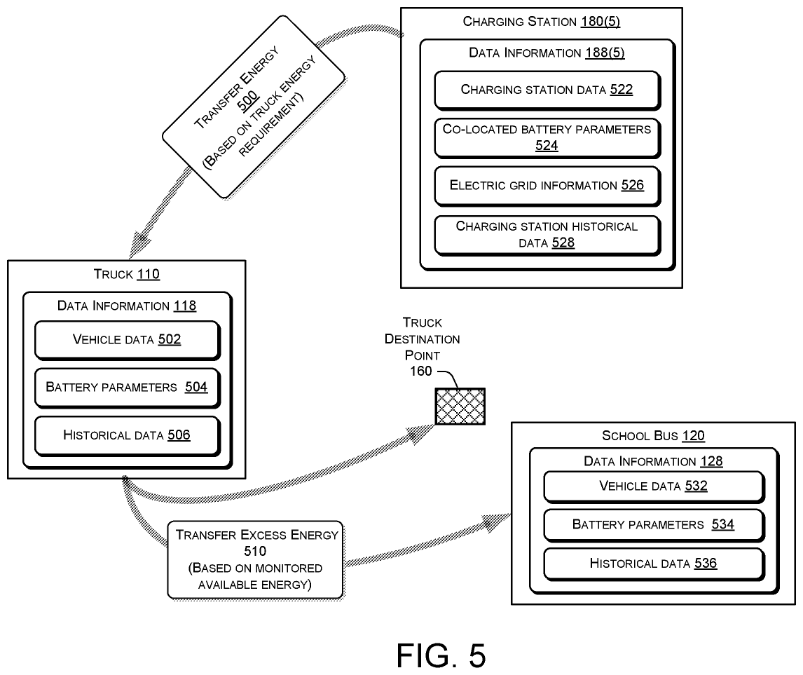

FIG. 5 is a block diagram of an example implementation of the distribution of energy between the network components based on different energy distribution plans. By way of illustration and not limitation, the energy distribution management server 130 may be assumed to control or operate the charging station 180(5), truck 110, and the school bus 120 as network components in the energy distribution network 100.

In one embodiment, the charging station 180(5) and the truck 110 may be configured to have different energy distribution operating periods. The energy distribution operating period may include the operating cycle for the distribution or consumption of energy, which can be an hourly cycle, daily cycle, weekly cycle, or other cycles that may be selected by an energy distribution management. For example, the charging station 180(5) may be configured to have an energy distribution operating period of 24 hours to supply or discharge 1200 kW of energy to mobile energy consuming components while the truck 110 may be configured to have an energy distribution operating period of 2 hours to consume a 100 kW of energy when traveling from a geolocation of the charging station 180(5) to the truck destination point 160. In this example, the first energy distribution plan (or initial configuration) for the charging station 180(5) is different from the first energy distribution plan (or initial configuration) of the truck 110. By way of illustration and not limitation, the first energy distribution plan for the charging station 180(5) is to discharge energy at an average rate of 50 kW per hour (i.e., 1200 kW divided by 24 hours) while the first energy distribution plan for the truck 110 is to consume energy at an average rate of 50 kW per hour (i.e., 100 kW divided by 2 hours) assuming that the truck 110 can still run at near-empty state-of-charge level as it reaches the truck destination point 160.

Following the example above, and based upon the first energy distribution plan of the truck 110, the truck 110 may receive the 100 kW of energy (i.e., truck 110's projected energy requirements) from the charging station 180(5) via a transfer energy 500. The truck 110 is then configured to consume 50 kW per hour based upon the first energy distribution plan. With the triggering of the truck 110's energy distribution operating period of 2 hours, the energy distribution management server 130 may monitor the truck 110 as it travels towards the truck destination point 160. The energy distribution management server 130 may use, for example, a parameter measurement threshold of 50 kW per hour (i.e., 100 kW divided by 2 hours) to monitor and detect conditions that may disrupt the initial configuration of the truck 110. Assuming that the monitored consumption of the truck 110 within a predetermined time period of 1 hour is 30 kW and the truck 110 is halfway towards the truck destination point 160, then this condition may indicate that the truck 110 has been averaging 30 kW per hour (i.e., 30 kW divided by 1 hour=30 kW per hour), which is below its initial configuration or parameter measurement threshold of 50 kW per hour under the first energy distribution plan. In this regard, and upon receiving of this information, the energy distribution management server 130 may re-calculate the optimal distribution of available energy in the truck 110.

In one example, for purpose of illustration and not limitation, the truck 110 may be reconfigured to transfer excess energy 510 to the school bus 120 based on the amount of its monitored excess available energy when averaging at about 30 kW per hour. In this example, the monitored excess available energy when the truck 110 is averaging at 30 kW per hour in the example above is 40 kW of energy (i.e., 100 kW minus (30 kW per hour×2 hours)=40 kW). With this excess available energy, the energy distribution management server 130 may notify the truck 110 and the school bus 120 to relocate at a particular location and the truck 110 may perform the transfer excess energy 510 to the school bus 120. The truck 110, in this case, may be considered as a second energy providing component while the school bus 120 can be treated as a second mobile energy consuming component. The truck 110 or the school bus 120 may be treated as an energy providing component or a mobile energy consuming component depending upon its configuration as defined in its current energy distribution plan.

Referencing FIG. 5, the data information 118 of the truck 110 may include (electric) vehicle data 502, vehicle battery parameter 504, and vehicle historical data 506. The data information 188(5) of the charging station 180(5) may include a charging station data 522, co-located battery parameter 524, electric grid information 526, and charging station historical data 528. The data information 128 of the school bus 120 may include (electric) vehicle data 532, vehicle battery parameter 534, and vehicle historical data 538.

Vehicle data 502, 532 may store the VIN that is unique to the truck 110 or school bus 120. They may also store the geolocation, a media access control (MAC) address of the device that is associated with the truck 110 or school bus 120, and/or other information of the truck 110 or school bus 120. The associated device of the truck 110 or school bus 120 may include an embedded electronic computer unit (ECU) or other system processors. In an example embodiment, the truck 110 or the school bus 120 may periodically transmit the vehicle data 502, 532 to the energy distribution management server 130.

Battery parameters 504, 534 may include information about the battery of the truck 110 or school bus 120. In one embodiment, the battery parameters 504, 534 may include parameters such as state-of-charge, depth of discharge, charging and discharging rates of the battery, or the battery lifetime. The state-of-charge may include a fraction of total energy or battery capacity that has been used over the total available energy in the battery. Depth of discharge may include the fraction of power that can be withdrawn from the battery without causing serious and often irreparable damage to the battery. The charging rate may include the amount of charge that is added to the battery per unit time. Discharging rate may include the amount of charge that is taken from the battery per unit time.

Historical data 506, 536 may include historical records that can be collected from the previous energy transfer sessions performed by the truck 110 or school bus 120. For example, the previous energy transfer sessions may include charging or discharging of energy at the charging station 180(5). Over time, the historical records may be used as training data to create the prediction model that can be used to predictively determine the optimal distribution of energy in the energy distribution network 100.

Charging station data 522 may include information about the charging station 180(5). The information can include the geolocation and identification of the charging station, MAC address of the device 186(5) that is associated with the charging station 180(5), or prices and availability of the charging station to trade energy whether through the co-located battery 192 or electrical grid source 194. The device associated with the charging station may include processors or system processors. In one embodiment, the charging station 180(5) may periodically transmit the charging station data 522 to the energy distribution management server 130.

Co-located battery parameters 524 may include information about one or more batteries that can be installed in the charging station. In one embodiment, the co-located battery parameters 524 may include parameters such as state-of-charge, depth of discharge, charging and discharging rates of the battery, or the battery lifetime.

Electric grid information 526 may include current prices or cost for charging energy via the electrical grid power source, availability of the electrical grid power source, charging and discharging rate, maximum capacity, and other information that relate to the use of the electrical power source in the charging station 180(5).

Charging station historical data 528 may include historical records collected from the previous pattern of charging or discharging of energy by the charging station 180(5). The historical records, for example, may include previous energy transfer sessions between the charging station 180(5) and other network components such as the truck 110.

In one embodiment, the energy distribution management server 130 may receive the data information of the truck 110, school bus 120, and the charging stations 180 to determine their respective current configurations and energy requirements. The energy distribution management server 130 may then generate the first energy distribution plan 138 based on the obtained current configurations and energy requirements of the truck 110, school bus 120, and the charging stations 180. In one embodiment, each of the truck 110, school bus 120, and the charging stations 180 may include different energy distribution plans. In this regard, each of these network components may be configured based upon their respective energy distribution plans. Thereafter, the energy distribution management server 130 may monitor disruptions based on the corresponding store measurement thresholds for these network components.

In one example, each of the charging station 180(5), truck 110, and the school bus 120 may include different energy distribution operating periods. Correspondingly, the energy distribution management server 130 may utilize different unit values and monitoring sequences for each of the charging station 180(5), truck 110, and the school bus 120. For example, the energy distribution management server 130 may use a predetermined time period with unit values of hours and minutes for the charging station 180(5) and truck 110, respectively. In this example, the energy distribution management server 130 may use different time intervals (i.e., predetermine time periods) to monitor the charging station 180(5) and truck 110. Further, the the energy distribution management server 130 may combine other data information such state-of-charge level, electric grid source prices, distance traveled, etc. in monitoring the charging station 180(5) and truck 110.

### Example Dynamic Configurations of a Mobile Energy Consuming Component Based on Different Energy Distribution Plans

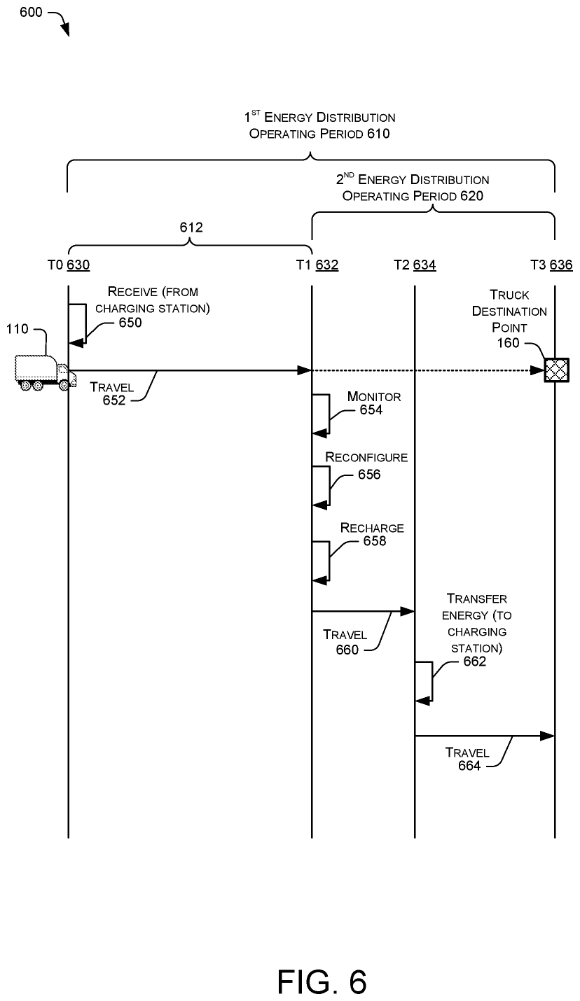

FIG. 6 is a swim diagram 600 showing a dynamic configuration of the mobile energy consuming component over different energy distribution operating periods. By way of illustration and not limitation, the swim diagram 600 shows energy transfer operations of the truck 110 from the time that it receives its projected energy requirement from the energy providing component up to the time that truck 110 reaches the truck destination point 160 as described above.

As shown, by way of illustration and not limitation, the swim diagram 600 may include a first energy distribution operating period 610 with a predetermined time period 612, a second energy distribution period 620, and time periods T0 630, T1 632, T2 634, and T3 636. The first energy distribution operating period 610 may include, for example, a desired duration of two hours, and truck 110 is assumed to reach the truck destination point 164 at the end of the second hour. In this example, the first energy distribution operating period 610 may include an initial operating cycle for the first energy distribution plan at time T0 630. The first energy distribution plan can be derived as described in FIG. 3 above.

By way of illustration and not limitation, at time T0 630, the truck 110 may receive 650 energy charges (e.g., 100 kW of energy) from a charging station (not shown) based upon a first energy distribution plan (not shown). The truck 110 may then configure its device 116 based upon the first energy distribution plan such as, by way of illustration and not limitation, setting its average consumption rate to 40 kW per hour and setting a minimum state-of-charge level of 20% to maintain proper operation to reach the truck destination point 160 in two hours. The truck may then travel 652 from its initial geolocation towards the truck destination point 160.

At time T1 632, which includes the predetermined time period 612 (e.g., one hour since T0 630), the energy distribution management server 130 may monitor 654 the state-of-charge level, location, and amount of distance traveled by the truck 110. With this data information, the energy distribution management server 130 may measure the average discharging rate of the truck 110 since the time T0 630. For example, and by way of illustration and not limitation, the truck 110 consumed about 50 kW for one hour (i.e., 50 kW per hour) and is now substantially located halfway to the truck destination point 160. In this example, the energy distribution management server 130 may reconfigure 656 the truck 110 to have more or less a new average discharging rate of 30 kW per hour (i.e., 100 kW−50 kW consumption−20 kW minimum state-of-charge level=30 kW) to reach the truck destination point 160 within the next hour while maintaining the minimum state-of-charge level of 20 kW.

At time T1 632 still, and assuming that the truck 110 may be further requested to transfer charges to an energy providing component such as the charging station 180(4) that operates on pure battery only, then the truck 110 may recharge 658 from an energy providing component e.g., charging station 180(1). The truck 110 may then travel 660 towards the geolocation of the charging station 180(4) for purposes of transferring the energy received at time T1 632.

At time T2 634 (e.g., about thirty minutes since T1 632), the truck 110 may transfer energy 662 to the charging station 180(4). For example, the truck 110 received an amount of 30 kW of energy at time T1 632. The truck 110 can then transfer this energy to the charging station 180(4) at time T2 634. In this example, the truck 110 may then continue to travel 664 towards the truck destination point 160. By way of illustration and not limitation, a summation of the predetermined time period 612 and the second energy distribution operating period 620 may be equal to the first energy distribution operating period 610.

### Example Energy Distribution Management Server

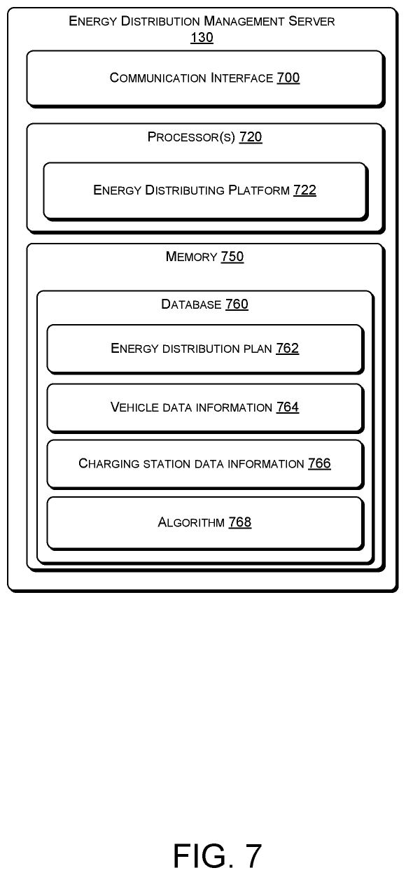

FIG. 7 is a block diagram of an example energy distribution management server 130 that can facilitate optimal distribution of energy throughout the energy distribution network 100. As shown, the energy distribution management server 130 may include a communication interface 700, one or more processors 720, and a memory 750. Processors 720 may include the energy distributing platform 722. The memory 750 may include a database 760 that further includes an energy distribution plan 762, vehicle data information 764, charging station data information 456, and algorithm 768.

In one example, the energy distribution management server 130 may establish communications with the network components through the communication interface 700. The communication interface 700 may include hardware, software, or a combination of hardware and software that transmits and/or receives data from the network components throughout the energy distribution network 100. Communication interface 700 may include a transceiver that facilitates wired or wireless communications through a cellular network or the broadband network. For example, the communications can be achieved via one or more networks, such as, but are not limited to, one or more of WiMax, a Local Area Network (LAN), Wireless Local Area Network (WLAN), a Personal area network (PAN), a Campus area network (CAN), a Metropolitan area network (MAN), or any broadband network, and further enabled with technologies such as, by way of example, Global System for Mobile Communications (GSM), Personal Communications Service (PCS), Bluetooth, WiFi, Fixed Wireless Data, 2G, 5G (new radio), etc.

Processor(s) 720 may be a central processing unit(s) (CPU), graphics processing unit(s) (GPU), both a CPU and GPU, or any other sort of processing unit(s). Each of the one or more processor(s) 720 may have numerous arithmetic logic units (ALUs) that perform arithmetic and logical operations as well as one or more control units (CUs) that extract instructions and stored content from processor cache memory, and then execute these instructions by calling on the ALUs, as necessary during program execution. The one or more processor(s) 720 may also be responsible for executing all computer applications stored in the memory, which can be associated with common types of volatile (RAM) and/or non-volatile (ROM) memory. For example, the processor(s) 720 may process data information that the energy distribution management server 130 receives through the communication interface 700. In another example, the processor(s) 720 may use the communication interface 700 to send the notifications to the network components.

The energy distributing platform 722 may include hardware, software, or a combination of hardware and software that may calculate the optimum distribution of energy for the network components. The energy distributing platform 722 may use different types and kinds of algorithms such as K-mean algorithm, maximum likelihood algorithm, nearest neighbor algorithm, etc. to calculate the optimal distribution of energy in the energy distribution network 100.

Memory 750 may be implemented using computer-readable media, such as computer-readable storage media. Computer-readable media includes, at least, two types of computer-readable media, namely computer-readable storage media and communications media. Computer-readable storage media includes, but is not limited to, Random Access Memory (RAM), Dynamic Random Access Memory (DRAM), Read-Only Memory (ROM), Electrically Erasable Programmable Read-Only Memory (EEPROM), flash memory or other memory technology, Compact Disc—Read-Only Memory (CD-ROM), digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device. As defined herein, computer-readable storage media do not consist of and are not formed exclusively by, modulated data signals, such as a carrier wave. In contrast, communication media may embody computer-readable instructions, data structures, program modules, or other data in a modulated data signal, such as a carrier wave, or other transmission mechanisms. The memory 750 may also include a firewall. In some embodiment, the firewall may be implemented as hardware in the energy distribution management server 130.

Database 760 may store collected data information, historical data, energy distribution plans, algorithms, prediction models, and other information that can be collected from the network components in the energy distribution network 100. Energy distribution plan 762 may store the energy distribution plans that can be generated based upon received energy requirements, current configurations of the network components, etc. In one example, each of the energy distribution plan may be associated with a particular energy distribution operating period. Vehicle data information 764 may store the data information of the mobile energy consuming components that can also be configured as energy providing components. The charging station data information 456 may store the data information, parameters, and other information of the energy providing components.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. One or more non-transitory computer-readable storage media storing computer-executable instructions that upon execution cause one or more computers to collectively perform acts comprising:
optimizing, at a server, a distribution of energy in an energy distribution network that comprises a plurality of energy providing components, wherein each energy providing component is suitably configured to at least transfer energy to a mobile energy consuming device;
generating, at the server, a first energy distribution plan based upon an optimized distribution of energy throughout the energy distribution network;
dynamically determining, at the server, a condition that triggers an adjustment of the first energy distribution plan, and in response to the determined condition that triggers the adjustment:
generating a second energy distribution plan that includes a transfer of energy from a first energy providing component of the plurality of energy providing components to a first mobile energy consuming device, wherein the transfer of energy from the first energy providing component is not a part of the first energy distribution plan;
sending a notification to the first mobile energy consuming device to relocate to a first location for the transfer of energy from the first energy providing component; and
sending a notification to the first energy providing component to transfer energy to the first mobile energy consuming device at the first location.

2. The one or more non-transitory computer-readable storage media of claim 1, wherein the first mobile energy consuming component includes an electric vehicle.

3. The one or more non-transitory computer-readable storage media of claim 2, wherein the first energy providing component in the second energy distribution plan includes a second mobile energy consuming component.

4. The one or more non-transitory computer-readable storage media of claim 1, wherein the first energy providing component includes an electric vehicle or a charging station.

5. The one or more non-transitory computer-readable storage media of claim 1, the acts further comprising: determining, by the server, energy requirements and current configurations of the energy providing components; and calculating the first energy distribution plan based upon the determined energy requirements and current configurations of the energy providing components.

6. The one or more non-transitory computer-readable storage media of claim 1, the acts further comprising: determining, by the server, characteristics of surrounding conditions in the energy distribution network; and calculating the first energy distribution plan based upon the determined characteristics of surrounding conditions.

7. The one or more non-transitory computer-readable storage media of claim 1, the acts further comprising:
configuring the energy providing components based upon the first energy distribution plan, and in response to the determined condition that triggers the adjustment:
re-configuring the energy providing components based upon the second energy distribution plan.

8. The one or more non-transitory computer-readable storage media of claim 1, wherein the determining of the condition that triggers the adjustment of the first energy distribution plan includes a use of one or more parameter measurement thresholds that are associated with the first energy distribution plan.

9. The one or more non-transitory computer-readable storage media of claim 8, wherein the parameter measurement thresholds that are associated with the first energy distribution plan are different from parameter measurement thresholds that are associated with the second energy distribution plan.

10. A network server, comprising:
one or more processors; and
memory including a plurality of computer-executable components that are executable by the one or more processors to perform a plurality of actions, the plurality of actions comprising:
optimizing, at a server, a distribution of energy in an energy distribution network that comprises a plurality of energy providing components, wherein each energy providing component is suitably configured to at least transfer energy to a mobile energy consuming device;
generating, at the server, a first energy distribution plan based upon an optimized distribution of energy;
dynamically determining, at the server, a condition that triggers an adjustment of the first energy distribution plan, and in response to the determined condition that triggers the adjustment:
generating a second energy distribution plan that includes a transfer of energy from a first energy providing component of the plurality of energy providing components to a first mobile energy consuming device, wherein the transfer of energy from the first energy providing component is not a part of the first energy distribution plan;
sending a notification to the first mobile energy consuming device to relocate to a first location for the transfer of energy from the first energy providing component; and
sending a notification to the first energy providing component to transfer energy to the first mobile energy consuming device at the first location.

11. The network of claim 10, wherein the first mobile energy consuming component includes an electric vehicle.

12. The network of claim 11, wherein the first energy providing component in the second energy distribution plan includes a second mobile energy consuming component.

13. The network of claim 10, wherein the first energy providing component includes an electric vehicle or a charging station.

14. The network of claim 10, the plurality of actions further comprising: determining, by the server, energy requirements and current configurations of the energy providing components; and calculating the first energy distribution plan based upon the determined energy requirements and current configurations of the energy providing components.

15. The network of claim 10, the plurality of actions further comprising: determining, by the server, characteristics of surrounding conditions in the energy distribution network; and calculating the first energy distribution plan based upon the determined characteristics of surrounding conditions.

16. The network of claim 10, the plurality of actions further comprising:
configuring the energy providing components based upon the first energy distribution plan, and in response to the determined condition that triggers the adjustment:
re-configuring the energy providing components based upon the second energy distribution plan.

17. The network of claim 10, wherein the determining of the condition that triggers the adjustment of the first energy distribution plan includes a use of one or more parameter measurement thresholds that are associated with the first energy distribution plan.

18. A computer-implemented method, comprising:
generating, at a server, a first energy distribution plan;
determining, at the server, a condition that triggers an adjustment of the first energy distribution plan, and in response to a determined condition that triggers the adjustment:
generating a second energy distribution plan that includes a transfer of energy from a first energy providing component of plurality of energy providing components to a first mobile energy consuming device, wherein the transfer of energy from the first energy providing component is not a part of the first energy distribution plan;
sending a notification to the first mobile energy consuming device to relocate to a first location for the transfer of energy from the first energy providing component; and
sending a notification to the first energy providing component to transfer energy to the first mobile energy consuming device at the first location.

19. The computer-implemented method of claim 18, wherein the first mobile energy consuming component includes an electric vehicle.

20. The computer-implemented method of claim 18, wherein the first energy providing component in the second energy distribution plan includes a second mobile energy consuming component.
